(19) United States
(12) Patent Application Publication
(10) Pub. No.: US 2023/0378545 A1
(43) Pub. Date: Nov. 23, 2023

(54) METHODS AND SYSTEMS FOR FORMING ELECTRODE STACKS

(71) Applicant: Cuberg, Inc., San Leandro, CA (US)

(72) Inventors: Alun Thomas, San Leandro, CA (US); Jennifer Noud, San Leandro, CA (US)

(73) Assignee: Cuberg, Inc., San Leandro, CA (US)

(21) Appl. No.: 18/321,608

(22) Filed: May 22, 2023

Related U.S. Application Data
(60) Provisional application No. 63/365,157, filed on May 23, 2022.

(51) Int. Cl. H01M 10/0583

(52) U.S. Cl. CPC H01M 10/0583

(57) ABSTRACT

Described herein are methods and systems for forming electrode stacks. For example, a method may comprise applying in-plane tension to a separator sheet and inspecting the separator sheet while applying the in-plane tension. This under-tension allows identifying any defects on the separator sheets that are not curable by tension, e.g., permanent wrinkles, tears, contaminants, and the like. Furthermore, this in-plane tension can be used for stacking and maintained while an electrode is placed over the separator. The tension can be formed by positioning vacuum clamps along the opposite edges (e.g., long edges) of the separator sheet. For example, one vacuum clamp can extend along the entire separator edge. Alternatively, multiple clamps can be distributed along the edge. Furthermore, additional clamps can be positioned along the remaining two edges (of the rectangular separator sheet). The vacuum clamps can move in various directions and/or rotate to apply the in-plane tension.

### CROSS-REFERENCE TO RELATED APPLICATIONS

This application claims the benefit under 35 U.S.C. § 119(e) of US Provisional Patent Application No. 63/365,157, filed on 2023 May 23, which is incorporated herein by reference in its entirety for all purposes.

### BACKGROUND

Battery electrodes require precise alignment and stretching/tensioning in an electrochemical cell to ensure that charge-carrying ions can reach their respective sites during the charging and discharging of the cell. For example, the charging/discharging of a lithium cell (e.g., a lithium-ion ion cell, a lithium metal cell) involves transferring lithium ions between the positive and negative electrodes. For example, charging involves transferring lithium ions from the positive electrode through the separator and to the negative electrode and converting these lithium ions to lithium metal on the negative electrode. Discharging involves, converting this lithium metal on the negative electrode into lithium ions and transferring these lithium ions through the separator to the positive electrode. If the separator is wrinkled, misaligned, or damaged, various undesirable conditions may occur, e.g., uneven current density distribution, shorts, and the like.

Furthermore, the alignment of the electrodes and separator is critical. For example, if the negative electrode is not able to capture lithium ions released from the positive electrode during the charge, undesirable lithium-metal deposits can form within the cell causing internal shorts and other undesirable effects. As such, the footprint of a positive electrode is typically smaller than and falls within the footprint of a corresponding negative electrode. Overall, a separator sheet needs to be positioned between the electrodes and also needs to typically extend past the boundary of the negative electrode. Separator sheets tend to be very thin and difficult to align and maintain wrinkle-free. Various systems have been proposed to establish and maintain the electrode-electrode and electrode-separator orientations with various levels of success.

### SUMMARY

Described herein are methods and systems for forming electrode stacks. For example, a method may comprise applying in-plane tension to a separator sheet and inspecting the separator sheet while applying the in-plane tension. This under-tension allows identifying any defects on the separator sheets that are not curable by tension, e.g., permanent wrinkles, tears, contaminants, and the like. Furthermore, this in-plane tension can be used for stacking and maintained while an electrode is placed over the separator. The tension can be formed by positioning vacuum clamps along the opposite edges (e.g., long edges) of the separator sheet. For example, one vacuum clamp can extend along the entire separator edge. Alternatively, multiple clamps can be distributed along the edge. Furthermore, additional clamps can be positioned along the remaining two edges (of the rectangular separator sheet). The vacuum clamps can move in various directions and/or rotate to apply the in-plane tension.

In some examples, a method for forming an electrode stack comprises applying in-plane tension to a separator sheet at least along a first axis by: (a) positioning a first one of vacuum clamps along a first separator edge of the separator sheet, (b) positioning a second one of the vacuum clamps along a second separator edge of the separator sheet, opposite of the first separator edge, (c) reducing pressure within vacuum ports of the vacuum clamps thereby forcing the separator sheet against the vacuum clamps, and (c) moving the vacuum clamps at least along the first axis relative to each other. The method also comprises inspecting the separator sheet while applying the in-plane tension.

In some examples, inspecting the separator sheet is performed while moving the vacuum clamps. For example, moving the vacuum clamps comprises at least one of (a) moving the vacuum clamps relative to each other along the first axis or (b) rotating at least one of the vacuum clamps about an axis perpendicular to a plane containing the first axis. Alternatively, moving the vacuum clamps comprises both (1) moving the vacuum clamps relative to each other along the first axis and (2) rotating at least one of the vacuum clamps about an axis perpendicular to a plane containing the first axis. In some examples, the first separator edge and the second separator edge are parallel to each other and perpendicular to the first axis.

In some examples, the pressure within vacuum ports is selected and maintained to overcome the porosity of the separator sheet thereby allowing air to leak through a first portion of the separator in contact with the first one of the vacuum clamps and through a second portion of the separator in contact with the second one of vacuum clamps. In some examples, the first one of the vacuum clamps extends along at least 80% of the length of the first separator edge. The second one of the vacuum clamps extends along at least 80% of the length of the second separator edge.

In some examples, applying the in-plane tension to the separator sheet comprises (a) positioning a third one of the vacuum clamps along a third separator edge of the separator sheet, and (b) positioning a fourth one of the vacuum clamps along a fourth separator edge of the separator sheet, opposite the third separator edge. The third separator edge is parallel to the fourth separator edge and is perpendicular to each of the first separator edge and the second separator edge. The in-plane tension to the separator sheet is further applied along a second axis, perpendicular to the first axis.

In some examples, applying the in-plane tension to the separator sheet comprises (a) positioning a first additional one of the vacuum clamps along the first separator edge of the separator sheet such that the first one and the first additional one of the vacuum clamps are distributed along the first separator edge; and (b) positioning a second additional one of the vacuum clamps along the second separator edge of the separator sheet, such that the second one and the second additional one of the vacuum clamps are distributed along the second separator edge.

In some examples, the method further comprises (a) picking and stacking the separator sheet on a stacking module to form the electrode stack; and (b) releasing the in-plane tension applied to the separator sheet. For example, picking and stacking the separator sheet is performed while applying the in-plane tension to the separator sheet.

In some examples, the method further comprises (a) releasing the in-plane tension to the separator sheet before picking and stacking the separator sheet on the stacking module; (b) applying the in-plane tension to the separator sheet at least along the first axis while the separator sheet is positioned on the stacking module; and (c) inspecting the separator sheet while applying the in-plane tension and while the separator sheet is positioned on the stacking module. For example, applying the in-plane tension to the separator sheet at least along the first axis while the separator sheet is positioned on the stacking module comprises pulling at least two opposite edges of the separator sheet below the plane containing the first axis. In some examples, the separator sheet is positioned on the stacking module over an electrode while pulling at least two opposite edges of the separator sheet below the plane containing the first axis.

In some examples, the method further comprises stacking an electrode over the separator sheet, and repeating operations comprising (a) applying the in-plane tension, (b) inspecting, (c) picking and stacking, and (d) releasing the in-plane tension at least once for one or more additional separator sheets.

In some examples, a method for forming an electrode stack comprises stacking a separator sheet and an electrode on a stacking platform using a stacking module comprising vacuum clamps. Specifically, stacking the separator sheet comprises applying in-plane tension to the separator sheet at least along a first axis by: (a) positioning a first one of the vacuum clamps along a first separator edge of the separator sheet, (b) positioning a second one of the vacuum clamps along a second separator edge of the separator sheet, opposite of the first separator edge, (c) reducing pressure within vacuum ports of the vacuum clamps thereby forcing the separator sheet against the vacuum clamps, and (d) moving the vacuum clamps at least along the first axis relative to each other. The method also comprises moving the stacking platform comprising a stack of the separator sheet and the electrode to an additional stacking module, different from the stacking module. The method comprises stacking an additional separator sheet and an additional electrode on the stacking platform and over the stack of the separator sheet and the electrode using an additional stacking module comprising additional vacuum clamps. Stacking the additional separator sheet comprises applying additional in-plane tension to the additional separator sheet at least along the first axis by: (a) positioning a first one of the additional vacuum clamps along a first separator edge of the additional separator sheet, (b) positioning a second one of the additional vacuum clamps along a second separator edge of the additional separator sheet, opposite of the first separator edge, (c) reducing pressure within vacuum ports of the additional vacuum clamps thereby forcing the additional separator sheet against the additional vacuum clamps, and (d) moving the additional vacuum clamps at least along the first axis relative to each other. In some examples, if an additional stacked layer is needed, the method comprises repeating (a) transferring the stacking platform and (b) stacking another additional separator sheet and another additional electrode.

In some examples, stacking the separator sheet and the electrode comprising: (a) unwinding a separator portion from a separator roll and tensioning the separator portion; (b) delivering an electrode using an electrode delivery unit and aligning the electrode relative to the separator portion thereby forming an initial stack comprising the electrode and the separator portion; (c) cutting the separator portion from the separator roll thereby forming the separator sheet; and (d) positioning and securing the stack comprising the separator sheet and the electrode on the stacking platform. For example, cutting the separator portion from the separator roll may be performed before transferring the stack to the stacking platform. Alternatively, cutting the separator portion from the separator roll is performed after transferring the stack to the stacking platform. In some examples, positioning the stack on the stacking platform comprises contacting the separator sheet with a vacuum picker such that the separator sheet is positioned between the vacuum picker and the electrode and such that the electrode is pressed against the separator sheet by a reduce pressured within pores of the separator.

These and other embodiments are described further below with reference to the figures.

### BRIEF DESCRIPTION OF THE DRAWINGS

FIG. 1A is a schematic cross-sectional side view of an electrode stack illustrating the relative alignment of different electrodes and separator sheets, in accordance with some examples.

FIG. 1B is a schematic top view of the electrode stack in FIG. 1A, illustrating the relative alignment of the separator and negative electrode, in accordance with some examples.

FIG. 2 is a process flowchart corresponding to a method of forming an electrode stack, such as the electrode stack in FIG. 1A, in accordance with some examples.

FIGS. 3A-3C are schematic top views of a separator and vacuum clamps, applying in-plane tension on the separator, in accordance with some examples.

FIG. 3D is a schematic side view of the separator and vacuum clamps of FIG. 3C, applying in-plane tension on the separator, in accordance with some examples.

FIG. 3E is an expanded schematic side view of the vacuum clamp and a portion of the separator in FIG. 3D, illustrating various features of the vacuum clamp, in accordance with some examples.

FIGS. 4A-4D are schematic side views of an electrode stack during various stages of forming the electrode stack, in accordance with some examples.

FIG. 5A is a schematic perspective view of a stacking module for stacking a separator sheet and an electrode on a stacking platform, in accordance with some examples.

FIG. 5B is a schematic perspective view of a stacking line comprising multiple stacking modules, each used for stacking a separator sheet and an electrode on a stacking platform that is movable among different stacking modules, in accordance with some examples.

FIG. 6 is a process flowchart corresponding to a method of forming an electrode stack using a stacking line in FIG. 5B, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

As noted above, battery separators and electrodes require precise alignment. The alignment is achieved by either winding electrodes and separators into multi-layered spiral/jellyroll-like structures or stacking multiple electrodes together. Winding provides a very efficient way of forming cells and is generally limited to cylindrical cells (e.g., 18650 cells). While some prismatic cells can be also formed with wound electrodes, these types of cells have various limitations and restrictions (e.g., tight bend radius, unfilled corner pockets).

Alternatives to the winding design described above include the stacking of individual electrodes, which can be further subdivided into (a) Z-folding/accordion-style folding of the separate and (b) single-sheet stacking. Both designs generally provide improved battery characteristics in terms of energy density, interior heat transfer, and rate capabilities/cycle time. However, these processes involve extensive electrode and separator handing. Furthermore, handling the separator during this process and, in particular, applying tension to the separator has been challenging. However, stacked cells have various advantages over wound cells. For example, wound prismatic cells tend to have different compression levels at the turn portions and flat portions, which can cause wave deformation and non-uniform performance. On the other hand, maintaining uniform compression in stacked cells is generally not an issue. Furthermore, each electrode in a stacked cell has a tab leading to more uniform current densities within the cell. Finally, the stacking designs tend to provide much higher packing densities, which is particularly important from the volumetric capacity standpoint (e.g., for aircraft applications).

In a Z-folding approach, a continuous separator sheet is directed by guide rollers and secured to a stacking plate, such that the plate and guide rollers are movable relative to each other. For example, the guide rollers can move across the plate, and the separator sheet is affixed to the plate's edges using clamps. An electrode is then placed on the separator sheet. The guide rollers then move to the opposite edge of the plate, covering the electrode with the separator sheet. The process is repeated for each electrode in the stack. The Z-folding process has a drawback in its cycle time, taking 3 seconds for each separator layer. It should be noted that various compressive stresses are exerted onto the electrode and separator in this Z-folding approach, while the separator is subject to bending stresses. These stresses depend on the folding tool and the structure of the separator. All these stress and folding parameters can impact the performance of the battery.

In the single-sheet stacking approach, individual sheets of the separator are used for each stack layer. In other words, an individual disjoined separator sheet is provided between each pair of positive and negative electrodes. In this process, mechanical stresses applied to the separator sheets and electrodes have a predominantly compressive effect with no bending stress being applied. Furthermore, the volume strain induced during the battery operation leads to additional compressive forces. However, handling, aligning, and inspecting individual separator sheets while forming an electrode stack can be challenging.

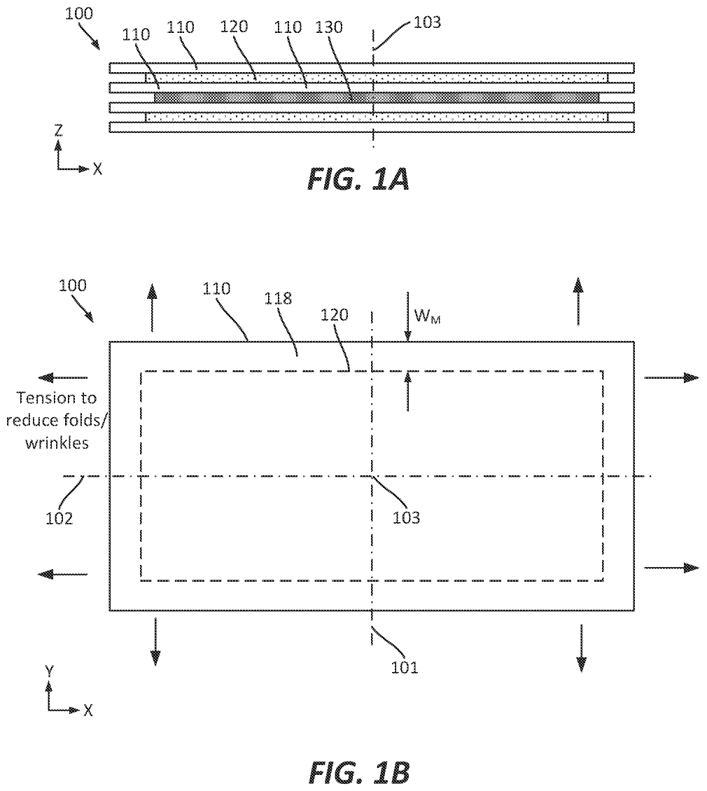

FIG. 1A is a schematic cross-sectional side view of electrode stack 100 illustrating the relative alignment of different electrodes (e.g., negative electrodes 120 and positive electrodes 130) and separator sheets 110, in accordance with some examples. Electrode stack 100 is formed by alternating negative electrodes 120 and positive electrodes 130 and placing one separator sheet 110 between each adjacent pair of negative electrodes 120 and positive electrodes 130. Electrode stack 100 is defined by stacking axis 103, which defines the direction along which negative electrodes 120, positive electrodes 130, and separator sheets 110 are stacked.

Positive electrodes 130 have the smallest footprint, which has to be positioned within the footprint of negative electrodes 120 (to ensure that lithium ions released from positive electrodes 130 reach negative electrodes 120 and are not plated as lithium dendrites elsewhere). Separator sheets 110 have the largest footprint extending beyond the footprint of negative electrodes 120, e.g., as schematically shown in FIG. 1B. It should be noted that separator sheets 110 are individual disjointed sheets. The number of separator sheets 110 in electrode stack 100 is roughly the same as the number of electrodes (e.g., one more than the number of electrodes if separator sheets 110 when separator sheets 110 are used as the external/outmost layers of electrode stack 100, e.g., as shown in FIG. 1A.

FIG. 1B is a schematic top view of electrode stack 100 in FIG. 1A illustrating the relative alignment of separator sheet 110 and negative electrode 120 in all in-plane directions perpendicular to stacking axis 103, in accordance with some examples. The degree to which separator sheet 110 extends past negative electrode 120 can be characterized by margin 118 having a margin width (W_{M}), which can be between 0.5 millimeters and 10 millimeters or, more specifically, between 1 millimeter and 5 millimeters. The margin width (W_{M}) depends on the component alignment precision, the presence of any conductive components around the stack, and the other factors. It should be noted that this offset can be used to engage/handle each separator sheet 110 without contacting negative electrodes 120. The contact with any electrodes should be generally minimized.

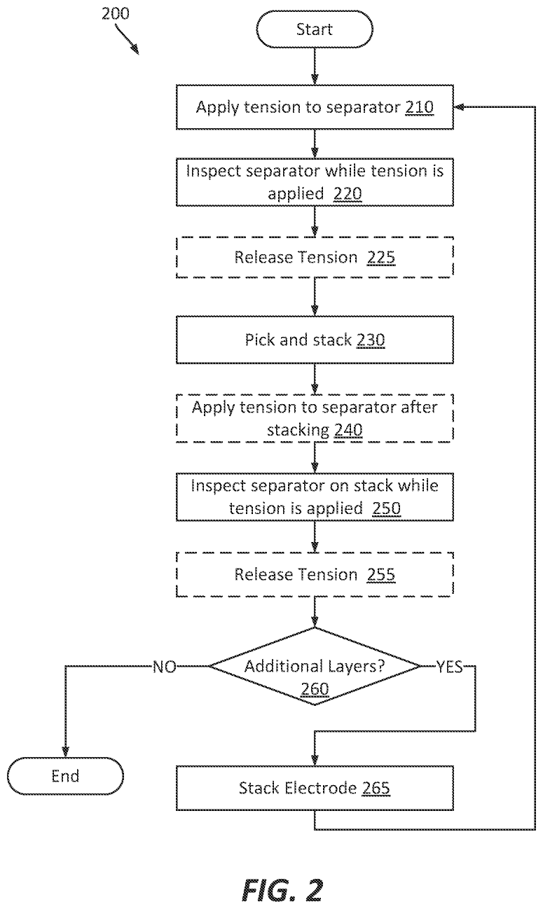

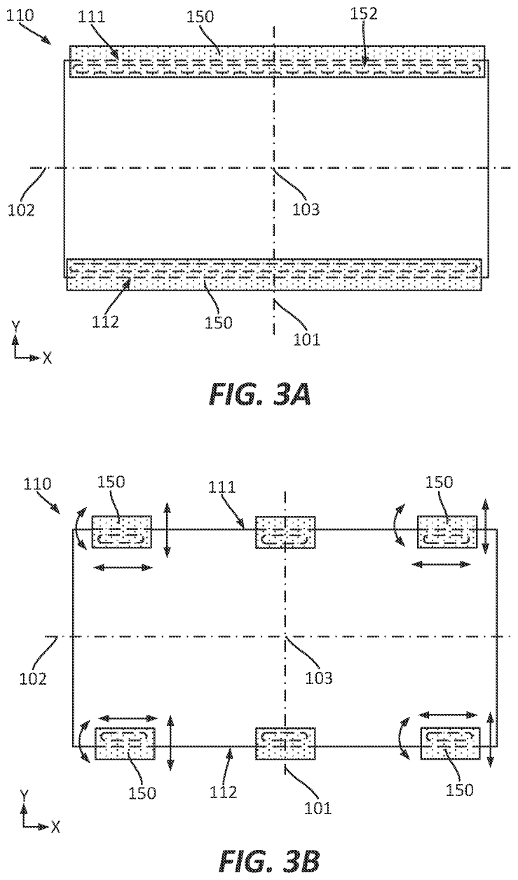

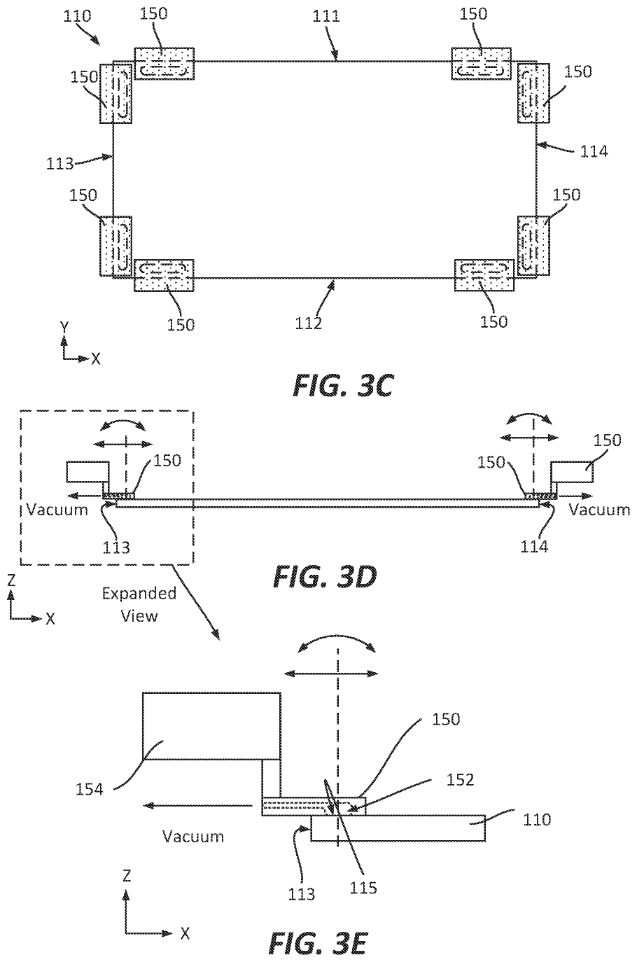

FIG. 2 is a process flowchart corresponding to method 200 of forming electrode stack 100, such as an electrode stack in FIG. 1A, in accordance with some examples. In some examples, method 200 comprises (block 210) applying in-plane tension to separator sheet 110 at least along first axis 101, e.g., as schematically shown in FIGS. 3A-3C. The in-plane tension can be applied using vacuum clamps 150, which engage separator sheet 110 along its edges and move/rotate in various directions to ensure sufficient tension.

Specifically, applying the in-plane tension to separator sheet 110 may comprise (a) positioning a first one of vacuum clamps 150 along first separator edge 111 of separator sheet 110, (b) positioning a second one of vacuum clamps 150 along second separator edge 112 of separator sheet 110, opposite of first separator edge 111, and (c) reducing the pressure within vacuum ports 152 of vacuum clamps 150 thereby forcing separator sheet 110 against vacuum clamps 150. The pressure within vacuum ports 152 can be selected based on the opening area of vacuum ports 152, facing separator sheet 110. Furthermore, the pressure within vacuum ports 152 is selected and maintained to overcome the porosity of separator sheet 110. It should be noted that some air may leak through separator sheet 110 while the pressure within vacuum ports 152 is reduced. Specifically, reducing the pressure within vacuum ports 152 forces separator sheet 110 against vacuum clamps 150. At the same time, the pressure should not cause wrinkling of separator sheet 110 at the interface with each vacuum ports 152. The wrinkling mitigation can also be achieved by providing support to separator sheet 110 at each vacuum port 152 and minimizing the largest cross-sectional size of the openings forming each vacuum port 152 thereby preventing separator sheet 110 from protruding into these openings. For example, the largest cross-sectional size of the openings forming each vacuum port 152 can be less than 3 millimeters, less than 2 millimeters, or even less than 1 millimeter. This size depends on the bendability of separator sheet 110 and the vacuum levels used in vacuum port 152.

In some examples, applying the in-plane tension to separator sheet 110 further comprises aligning vacuum clamps 150 relative to first separator edge 111. For example, a stacking system, which vacuum clamps 150 is a part of, can include a vision/guiding system for detecting the position of first separator edge 111 and instructing actuators, coupled to vacuum clamps 150, to position vacuum clamps 150 relative to first separator edge 111. In some examples, the overlap between separator sheet 110 and vacuum clamps 150 needs to be minimized, e.g., vacuum clamps 150 needs to be positioned as close as possible relative to first separator edge 111.

In some examples, applying the in-plane tension to separator sheet 110 further comprises moving vacuum clamps 150 at least along first axis 101 (with different vacuum clamps 150 moving relative to each other). This moving operation is performed after reducing pressure within vacuum ports 152 of vacuum clamps 150. For example, the first one of vacuum clamps 150 (positioned along first separator edge 111 of separator sheet 110) is moved further away from the second one of vacuum clamps 150 (positioned along second separator edge 112 of separator sheet 110) thereby stretching separator sheet 110 along first axis 101. The tension applied to separator sheet 110 can be monitored using a vision/guiding system, which vacuum clamps 150 is a part of. For example, moving actuators coupled to vacuum clamps 150 can include load cells to determine the tension force.

In the same or other examples, the moving operation involves rotating at least one of vacuum clamps 150 about an axis perpendicular to a plane containing first axis 101 as, e.g., schematically shown in FIG. 3B. In other words, the rotation axis can be parallel to stacking axis 103. It should be noted that different vacuum clamps 150 can rotate in different directions. These rotation directions and the rotation degree can be determined by a vision inspection system of the vision/guiding system. For example, the vision inspection system can be continuously scanning the surface of separator sheet 110 for wrinkles and guiding the rotation of vacuum clamps 150 based on these scan results.

FIG. 3E illustrates vacuum clamp actuator 154, which can be used for moving corresponding vacuum clamp 150. In some examples, vacuum clamps 150 positioned along different edges of separator sheet 110 are connected to different vacuum clamp actuators 154. Clamp actuator 154 can include one or more linear and/or rotational actuators. Vacuum clamp 150 comprises vacuum port 152, which can be connected to a vacuum supply (controlled by a system controller). The opening of vacuum port 152 defines the size of the engaged portion 115 of separator sheet 110

Referring to FIG. 3A, in some examples, the first one of vacuum clamps 150 extends along at least 60%, at least 80%, or even at least 90% of the length of first separator edge 111. The second one of vacuum clamps 150 can also extend along at least 60%, at least 80%, or even at least 90% of the length of second separator edge 112. This approach ensures that the large portions of the separator edges remain supported. In other words, almost the entire edge is supported by the same vacuum clamp. This approach simplifies the system by reducing the number of system components that needs to be independently controlled. For example, only two vacuum clamps can be used to stretch separator sheet 110 along first axis 101, e.g., by moving one vacuum clamp relative to another.

Referring to FIG. 3B, in some examples, applying the in-plane tension to separator sheet 110 comprises positioning a first additional one of vacuum clamps 150 along first separator edge 111 of separator sheet 110 such that the first one and the first additional one of vacuum clamps 150 are distributed along first separator edge 111. Furthermore, applying the in-plane tension to separator sheet 110 may comprise positioning a second additional one of vacuum clamps 150 along second separator edge 112 of separator sheet 110, such that the second one and the second additional one of vacuum clamps 150 are distributed along second separator edge 112. This approach allows supporting separator edges close to the separator corner and, in more specific examples, to apply the in-plane tension to separator sheet 110 along second axis 102, perpendicular to first axis 101. For example, the first one and the first additional one of vacuum clamps 150 can be movable with respect to each other, e.g., along second axis 102. Similarly, the second one and the second additional one of vacuum clamps 150 can be movable with respect to each other, e.g., along second axis 102. Furthermore, additional vacuum clamps 150 can be distributed along the edges in between the corners thereby providing support to the edges away from the corners, e.g., as shown in FIG. 3B. While FIG. 3B illustrates one vacuum clamp 150 positioned at each corner and one vacuum clamp 150 positioned in between the corners (at least along first separator edge 111 and second separator edge 112), any number of vacuum clamps 150 can be positioned in between the corners. This number depends on the length of each edge (e.g., no clamps on short edges as shown in FIG. 3B or multiple clamps along particularly long edges). When multiple clamps in between the corners are used, these clamps can be distributed uniformly such that the spacing between each pair of adjacent clamps is the same. However, other examples are also within the scope. For example, the distribution may be selected based on the required tensioning within separator sheet 110.

Referring to FIGS. 3C and 3D, in some examples, applying the in-plane tension to separator sheet 110 comprises positioning a third one of vacuum clamps 150 along third separator edge 113 of separator sheet 110 and also positioning a fourth one of vacuum clamps 150 along fourth separator edge 114 of separator sheet 110, opposite third separator edge 113. In these examples, the in-plane tension to separator sheet 110 can be further applied along second axis 102, perpendicular to first axis 101. For example, the third one and the fourth one of vacuum clamps 150 can be movable with respect to each other along second axis 102.

Returning to FIG. 2A, in some examples, method 200 further comprises (block 220) inspecting separator sheet 110 while applying the in-plane tension. Various visual inspection systems are within the scope. Separator sheet 110 can be inspected for wrinkles, folds, debris, and other defects. Applying the in-plane tension while inspecting separator sheet 110 eliminates various correctable defects, e.g., temporary wrinkles and temporary folds, thereby reducing the false positive inspection results.

In some examples, method 200 comprises moving vacuum clamps 150 while inspecting separator sheet 110. For example, if a wrinkle is detected during the inspection, vacuum clamps 150 can be moved to see if this wrinkle can be eliminated. More generally, the tension applied to separator sheet 110 (the position of vacuum clamps 150 relative to each other) can be adjusted based on the inspection results.

Returning to FIG. 2A, in some examples, method 200 further comprises (block 225) releasing the tension from separator sheet 110, e.g., by increasing the pressure inside vacuum ports 152 (e.g., to ambient pressure or even above the ambient pressure). For example, releasing the tension from separator sheet 110 may be needed to transfer separator sheet 110 to another station (e.g., picking and stacking). This operation is optional, and, in some examples, the in-plane tension remains applied during later operations, e.g., picking and stacking separator sheet 110.

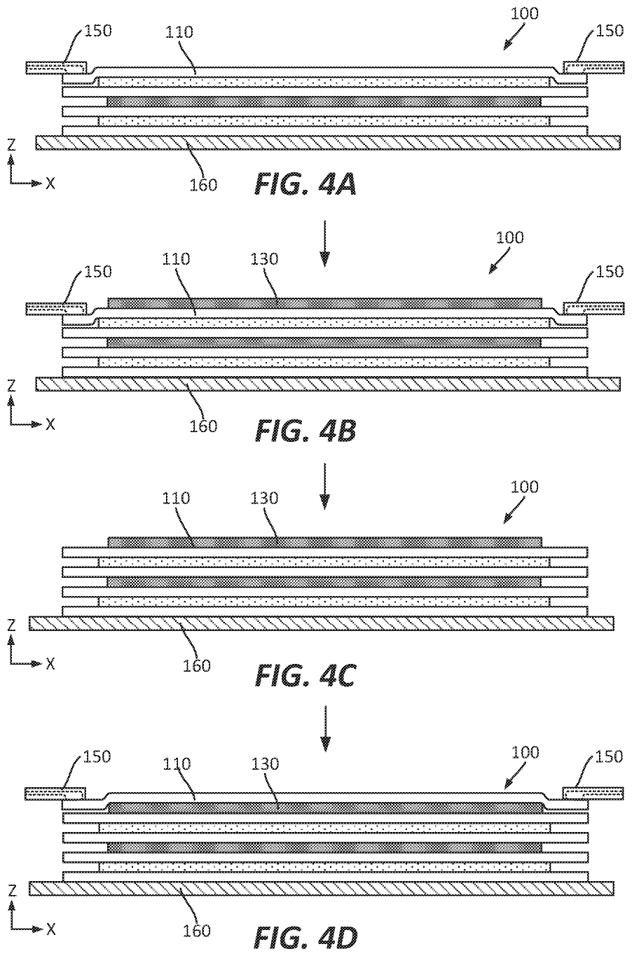

Referring to FIG. 2A, in some examples, method 200 further comprises (block 230) picking and stacking separator sheet 110 on stacking module 160 to form electrode stack 100 as, e.g., is shown schematically in FIG. 4A. In this example, picking and stacking separator sheet 110 is performed while applying the in-plane tension to separator sheet 110. For example, vacuum clamps 150 can be used for picking and stacking.

Alternatively, method 200 comprises (block 225) releasing the in-plane tension to separator sheet 110 prior to (block 230) picking and stacking separator sheet 110 on stacking module 160. Method 200 proceeds with (block 230) picking and stacking separator sheet 110 on stacking module 160 and (block 240) applying in-plane tension to separator sheet 110 at least along first axis 101 while separator sheet 110 is positioned on stacking module 160.

In some examples, applying the in-plane tension to separator sheet 110 at least along first axis 101 while separator sheet 110 is positioned on stacking module 160 comprises pulling at least two opposite edges of separator sheet 110 below the plane containing first axis 101 as, e.g., is schematically shown in FIG. 4A. During this pulling below the plane operation, separator sheet 110 can be positioned on stacking module 160 over an electrode or, more specifically, a partially formed stack of electrodes and separator sheets.

Returning to FIG. 2A, in some examples, method 200 further comprises (block 250) inspecting separator sheet 110 while applying the in-plane tension and while separator sheet 110 is positioned on stacking module 160. In some examples, method 200 proceeds with (block 255) releasing the tension from separator sheet 110 after the inspection. Alternatively, the tension is maintained during later operations, e.g., electrode stacking. In some examples, before the tension (applied by vacuum clamps 150) is released another device (e.g., a stacking gripper) engages separator sheet 110 such that separator sheet 110 is supported and the alignment of separator sheet 110 is maintained in the stack when vacuum clamps 150 release separator sheet 110. In other words, the tension application is transferred from vacuum clamps 150 to this other device.

If separator sheet 110 passes the inspection and additional layers are needed (block 260), method 200 proceeds with (block 265) stacking an electrode over separator sheet 110 as, e.g., is schematically shown in FIGS. 4B and 4C. If the tension was maintained during the electrode stacking (e.g., as shown in FIG. 4B), the tension can be released at this point.

As shown by the feedback loop in FIG. 2, method 200 can proceed with repeating operations comprising (a) applying the in-plane tension, (b) inspecting, (c) picking and stacking, and (d) releasing in-plane tension at least once for one or more additional separator sheets.

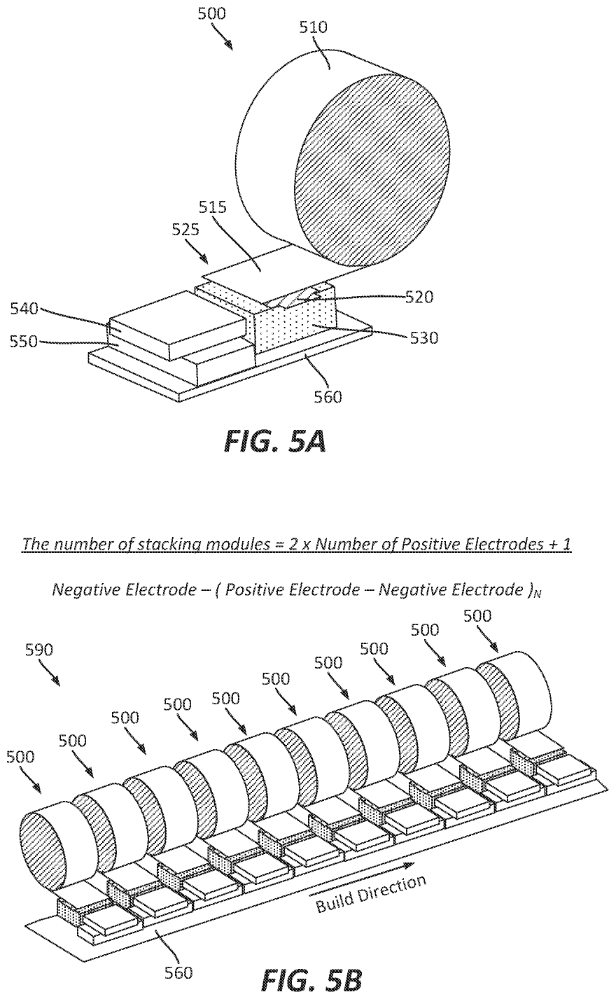

Electrode stack 100 formed using method 200 can be performed using the same stacking module or multiple stacking modules. FIG. 5A is a schematic perspective view of a stacking module 500 for stacking separator sheet 110 and electrode 520 on stacking platform 540, in accordance with some examples. In this example, stacking module 500 is configured to handle a specific electrode. For example, if electrode stack 100 comprises 17 electrodes (9 negative electrodes and 8 positive electrodes), 17 different stacking modules 500 will be used. In general, the number of stacking modules 500 used to form stacking line 590, which is shown in FIG. 5B, is double the number of positive electrodes+1. In some examples, an additional stacking module 500 can be used to add a separator sheet without a corresponding electrode.

Returning to FIG. 5A, stacking module 500 comprises separator roll 510 and a device (not shown) to unwind separator portion 515 from separator roll 510 and place separator portion 515 under tension. Stacking module 500 can also comprise electrode delivery unit 530 for delivering electrode 520 and aligning electrode 520 relative to separator portion 515. Stacking module 500 also comprises stacking platform 540 supported by stacking delivery unit 550 and configured to move stacking platform 540 relative to tool base 560 among different stacking modules. In other words, stacking platform 540 and stacking delivery unit 550 are shared by multiple stacking modules.

FIG. 5B is a schematic perspective view of stacking line 590 comprising multiple stacking modules 500, each used for stacking a separator sheet and an electrode on a corresponding stacking platform that is movable among different stacking modules 500, in accordance with some examples.

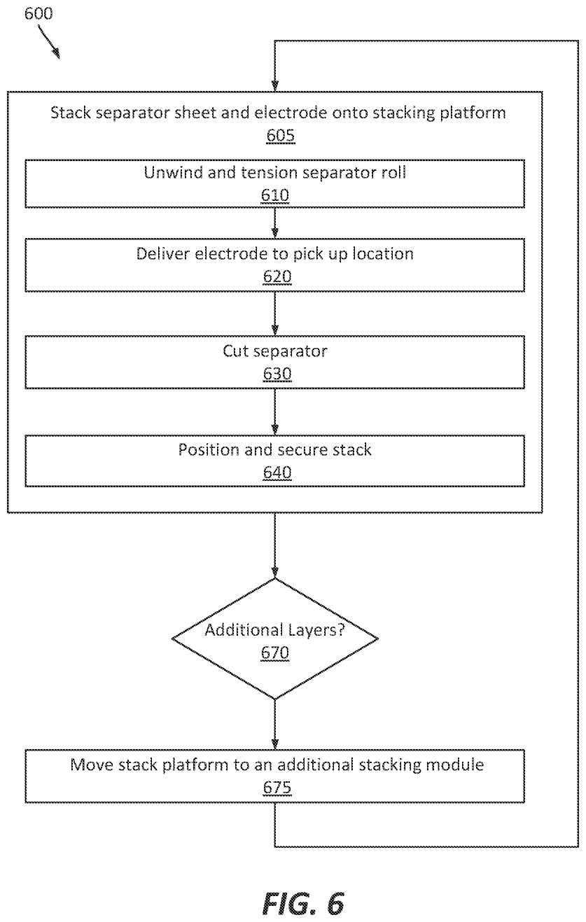

FIG. 6 is a process flowchart corresponding to method 600 of forming electrode stack 100 using stacking line 590 in FIG. 5B, in accordance with some examples. In some examples, method 600 comprises (block 605) stacking a separator sheet and an electrode on a stacking platform using a stacking module and (block 675) moving the stacking platform, when additional layers are needed (decision block 670). Specifically, moving the stacking platform enables stacking additional separator sheets and/or electrodes using one or more additional stacking modules, different from the stacking module (which may be referred to as a first stacking module). The process is repeated as needed (defined by decision block 670) for additional separator sheets and electrodes using the same stacking platform but different stacking modules (if additional stacked layers are needed).

In some examples, (block 605) stacking the separator sheet and the electrode comprises (block 610) unwinding separator portion 515 from separator roll 510 and tensioning separator portion 515. This stacking operation also comprises (block 620) delivering electrode 520 using electrode delivery unit 530 and aligning electrode 520 relative separator portion 515 thereby forming initial stack 525 comprising electrode 520 and separator portion 515. This stacking operation proceeds with (block 630) cutting separator portion 515 from separator roll 510 thereby forming a separator sheet. The operation also comprises (block 640) positioning and securing the stack comprising the separator sheet and the electrode on stacking platform 540.

In some examples, cutting separator portion 515 from separator roll 510 is performed before transferring the stack to stacking platform 540. Alternatively, cutting separator portion 515 from separator roll 510 is performed after transferring the stack to stacking platform 540.

In some examples, (block 640) positioning the stack on stacking platform 540 comprises contacting the separator sheet with a vacuum picker such that the separator sheet is positioned between the vacuum picker and the electrode and such that the electrode is pressed against the separator sheet by a reduce pressured within the pores of the separator.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

1. A method for forming an electrode stack, the method comprising:
applying in-plane tension to a separator sheet at least along a first axis by:
positioning a first one of vacuum clamps along a first separator edge of the separator sheet,
positioning a second one of the vacuum clamps along a second separator edge of the separator sheet, opposite of the first separator edge,
reducing pressure within vacuum ports of the vacuum clamps thereby forcing the separator sheet against the vacuum clamps, and
moving the vacuum clamps at least along the first axis relative to each other; and
inspecting the separator sheet while applying the in-plane tension.

2. The method of claim 1, wherein inspecting the separator sheet is performed while moving the vacuum clamps.

3. The method of claim 1, wherein moving the vacuum clamps comprises at least one of (a) moving the vacuum clamps relative to each other along the first axis or (b) rotating at least one of the vacuum clamps about an axis perpendicular to a plane containing the first axis.

4. The method of claim 1, wherein moving the vacuum clamps comprises both (1) moving the vacuum clamps relative to each other along the first axis and (2) rotating at least one of the vacuum clamps about an axis perpendicular to a plane containing the first axis.

5. The method of claim 1, wherein the first separator edge and the second separator edge are parallel to each other and perpendicular to the first axis.

6. The method of claim 1, wherein the pressure within vacuum ports is selected and maintained to overcome porosity of the separator sheet thereby allowing air to leak through a first portion of the separator in contact with the first one of the vacuum clamps and through a second portion of the separator in contact with the second one of vacuum clamps.

7. The method of claim 1, wherein:
the first one of the vacuum clamps extends along at least 80% of length of the first separator edge; and
the second one of the vacuum clamps extends along at least 80% of length of the second separator edge.

8. The method of claim 1, wherein:
applying the in-plane tension to the separator sheet comprises (a) positioning a third one of the vacuum clamps along a third separator edge of the separator sheet, and (b) positioning a fourth one of the vacuum clamps along a fourth separator edge of the separator sheet, opposite the third separator edge,
the third separator edge is parallel to the fourth separator edge and is perpendicular to each of the first separator edge and the second separator edge, and
the in-plane tension to the separator sheet is further applied along a second axis, perpendicular to the first axis.

9. The method of claim 1, wherein applying the in-plane tension to the separator sheet comprises:
positioning a first additional one of the vacuum clamps along the first separator edge of the separator sheet such that the first one and the first additional one of the vacuum clamps are distributed along the first separator edge; and
positioning a second additional one of the vacuum clamps along the second separator edge of the separator sheet, such that the second one and the second additional one of the vacuum clamps are distributed along the second separator edge.

10. The method of claim 1, further comprising:
picking and stacking the separator sheet on a stacking module to form the electrode stack; and
releasing the in-plane tension applied to the separator sheet.

11. The method of claim 10, wherein picking and stacking the separator sheet is performed while applying the in-plane tension to the separator sheet.

12. The method of claim 10, further comprising:
releasing the in-plane tension to the separator sheet before picking and stacking the separator sheet on the stacking module;
applying the in-plane tension to the separator sheet at least along the first axis while the separator sheet is positioned on the stacking module; and
inspecting the separator sheet while applying the in-plane tension and while the separator sheet is positioned on the stacking module.

13. The method of claim 12, wherein applying the in-plane tension to the separator sheet at least along the first axis while the separator sheet is positioned on the stacking module comprises pulling at least two opposite edges of the separator sheet below the plane containing the first axis.

14. The method of claim 13, wherein the separator sheet is positioned on the stacking module over an electrode while pulling at least two opposite edges of the separator sheet below the plane containing the first axis.

15. The method of claim 10, further comprising:
stacking an electrode over the separator sheet; and
repeating operations comprising (a) applying the in-plane tension, (b) inspecting, (c) picking and stacking, and (d) releasing the in-plane tension at least once for one or more additional separator sheets.

16. A method for forming an electrode stack, the method comprising:
stacking a separator sheet and an electrode on a stacking platform using a stacking module comprising vacuum clamps, wherein stacking the separator sheet comprises applying in-plane tension to the separator sheet at least along a first axis by:
positioning a first one of the vacuum clamps along a first separator edge of the separator sheet,
positioning a second one of the vacuum clamps along a second separator edge of the separator sheet, opposite of the first separator edge,
reducing pressure within vacuum ports of the vacuum clamps thereby forcing the separator sheet against the vacuum clamps, and
moving the vacuum clamps at least along the first axis relative to each other;
moving the stacking platform comprising a stack of the separator sheet and the electrode to an additional stacking module, different from the stacking module;
stacking an additional separator sheet and an additional electrode on the stacking platform and over the stack of the separator sheet and the electrode using an additional stacking module comprising additional vacuum clamps, wherein stacking the additional separator sheet comprises applying additional in-plane tension to the additional separator sheet at least along the first axis by:
positioning a first one of the additional vacuum clamps along a first separator edge of the additional separator sheet,
positioning a second one of the additional vacuum clamps along a second separator edge of the additional separator sheet, opposite of the first separator edge,
reducing pressure within vacuum ports of the additional vacuum clamps thereby forcing the additional separator sheet against the additional vacuum clamps, and
moving the additional vacuum clamps at least along the first axis relative to each other; and
if an additional stacked layer is needed, repeating (a) transferring the stacking platform and (b) stacking another additional separator sheet and another additional electrode.

17. The method of claim 16, wherein stacking the separator sheet and the electrode comprising:
unwinding a separator portion from a separator roll and tensioning the separator portion;
delivering an electrode using an electrode delivery unit and aligning the electrode relative to the separator portion thereby forming an initial stack comprising the electrode and the separator portion;
cutting the separator portion from the separator roll thereby forming the separator sheet; and
positioning and securing the stack comprising the separator sheet and the electrode on the stacking platform.

18. The method of claim 17, wherein cutting the separator portion from the separator roll is performed before transferring the stack to the stacking platform.

19. The method of claim 17, wherein cutting the separator portion from the separator roll is performed after transferring the stack to the stacking platform.

20. The method of claim 17, wherein positioning the stack on the stacking platform comprises contacting the separator sheet with a vacuum picker such that the separator sheet is positioned between the vacuum picker and the electrode and such that the electrode is pressed against the separator sheet by a reduce pressured within pores of the separator.
